(19) United States
(12) Patent Application Publication
(10) Pub. No.: US 2008/0172628 A1
(43) Pub. Date: Jul. 17, 2008

(54) User Experience for Creating Semantic Relationships

(75) Inventors: Shishir Mehrotra, Bellevue, WA (US); Shane Williams, Redmond, WA (US); Greg Friedman, Redmond, WA (US); Quentin Clark, Bellevue, WA (US); Steve De Mar, Seattle, WA (US); Josh Michaels, Seattle, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 11/623,124

(22) Filed: Jan. 15, 2007

(51) Int. Cl. G06F 3/048; G06F 7/00

(52) U.S. Cl. 715/771; 707/103 Y; 707/E17.055; 707/E17.142

(57) ABSTRACT

A computer user interface may be used to create and maintain semantic relationships between data objects on a computer system. Multiple sets of data objects identified by user selections, queries, searches, or other criteria may be presented in display panes on the user interface. Users may then select data objects via the user interface in order to view or create new relationships between the data objects. Based on the selection of the data objects and a determination of the associated data object types, a set of semantic relationships applicable to the selected data object or objects may be retrieved and displayed in the user interface. A user may subsequently select and create an appropriate semantic relationship between data objects, thereby not only establishing an association between the objects, but providing a specific and useful meaning to the association.

### FIELD OF THE INVENTION

Aspects of the present invention relate to a user interface and associated functionality in a computer system for creating and maintaining relationships between data objects stored on the system.

### BACKGROUND

The overall amount of data stored in computers as well as the number of different types of data stored in computers at home and at work has grown dramatically in recent years. As users rely more and more on computers for storing greater amounts and different kinds of data, they face the difficult task of keeping their data organized and readily accessible in a complex computer system. The sheer mass and growing complexity of a user's data often makes conventional techniques for storing and organizing data, such as basic hierarchical file systems, spreadsheets, and database tables, unsuitable for conveniently organizing all of a user's information on a computer system.

Previous attempts to provide users with tools for improving data organization have resulted in methods involving folders, file and directory hierarchy searching capabilities, metadata tags, and keywords. However, these existing solutions for organizing the data on a computer system lack some features to produce an adequate environment for users to quickly and intuitively define, create, and maintain relationships between different data objects. For example, although folders allow users to group sets of objects on a computer system, they do not provide support for establishing relationships between items that are not in the same group or folder hierarchy. In light of the increasingly complex and interconnected nature of information, data objects on modern computers often cannot easily be classified into homogenous groups. Rather, data objects often have a more complex relationship structure, for example, having a certain set of meaningful data connections (i.e., relationships) with certain other objects on the system, while having additional data relationships with other objects when the data is considered in a different context. Thus, simply grouping objects together is often inadequate for expressing the multiple different types of data relationships between objects on a computer system.

Additionally, metadata tags may provide users a flexible solution for associating a piece of information, such as a keyword value or property, with a data object. Commonly known searching techniques are then employed to identify different data objects in different physical locations that share a similar keyword value or property. However, metadata tags simply embed the keyword value or property into the data object, without providing a consistent and coherent meaning for the embedded data that can be understood and/or utilized by other objects. Thus, metadata tags are often unsuitable for defining relationships between different types of data objects and data objects from different sources or users. For example, a similar metadata tag found in two different objects might not indicate an actual connection between the two objects but may simply be the result of two different organizational systems expressing a different concept using a similar term. Accordingly, metadata tags and file system searching techniques are often unsuitable for organizing information in a computer system.

### SUMMARY

In light of the foregoing, aspects of the present invention are directed to creating and maintaining semantic relationships between data objects on a computer system. The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

According to certain aspects of the invention, a computer user interface may be used to display multiple sets of data objects in different display panes, for example, on a computer screen. Users may then select data objects via the user interface in order to view or create new relationships between the data objects. Based on the selection of the data objects and a determination of the associated data object types, a set of semantic relationships applicable to the selected data object or objects may be retrieved and displayed in the user interface. A user may subsequently select and create an appropriate semantic relationship between data objects, thereby not only establishing an association between the objects, but providing a specific and useful meaning to the association. Similar techniques may be used to execute a software action related to the selected data objects, such as e-mailing an object to the appropriate related recipient.

According to another aspect of the invention, a data object may be selected in a user interface to initiate a retrieval of other related data objects. In one example, an object is selected in a display pane, prompting a query for the subset of objects in a different display pane that have an existing semantic relationship with the selected object. Each retrieved object may be identified on the user interface, for example, by marking related objects or by filtering unrelated objects. A related object may then be selected in order to view and/or modify the existing semantic relationships for that object. According to yet another aspect of the invention, various organization modules and collection views may provide different techniques for viewing and selecting data objects for organizing the objects into relationships. For example, a related set of data objects may be displayed in the user interface as a grid, chart, hierarchy, map, a user create favorites list, etc.

### BRIEF DESCRIPTION OF THE DRAWINGS

The foregoing summary, as well as the following detailed description, is better understood when read in conjunction with the accompanying drawings, which are included by way of example, and not by way of limitation and in which like reference numerals indicate similar elements.

FIG. 1 illustrates a schematic diagram of a general-purpose digital computing environment in which certain aspects may be implemented.

FIG. 2 is an example of an illustrative user interface screenshot from a computer system in accordance with at least one aspect of the present invention.

FIG. 3 is a flow diagram showing an illustrative technique for creating semantic relationships in accordance with at least one aspect of the present invention.

FIG. 4 is a flow diagram showing an illustrative technique for retrieving and displaying semantic relationships in accordance with at least one aspect of the present invention.

FIGS. 5-7 are examples of illustrative user interface screenshots from a computer system maintaining semantic relationships between data objects in accordance with at least one aspect of the present invention.

FIGS. 8A-8D and 9A-9H are examples of illustrative screenshots of user interface components corresponding to collection views and organization modules in accordance with at least one aspect of the present invention.

### DETAILED DESCRIPTION

In the following description of the various embodiments, reference is made to the accompanying drawings, which form a part hereof, and in which is shown by way of illustration various embodiments in which features may be practiced. It is to be understood that other embodiments may be utilized and structural and functional modifications may be made.

### Illustrative Operating Environment

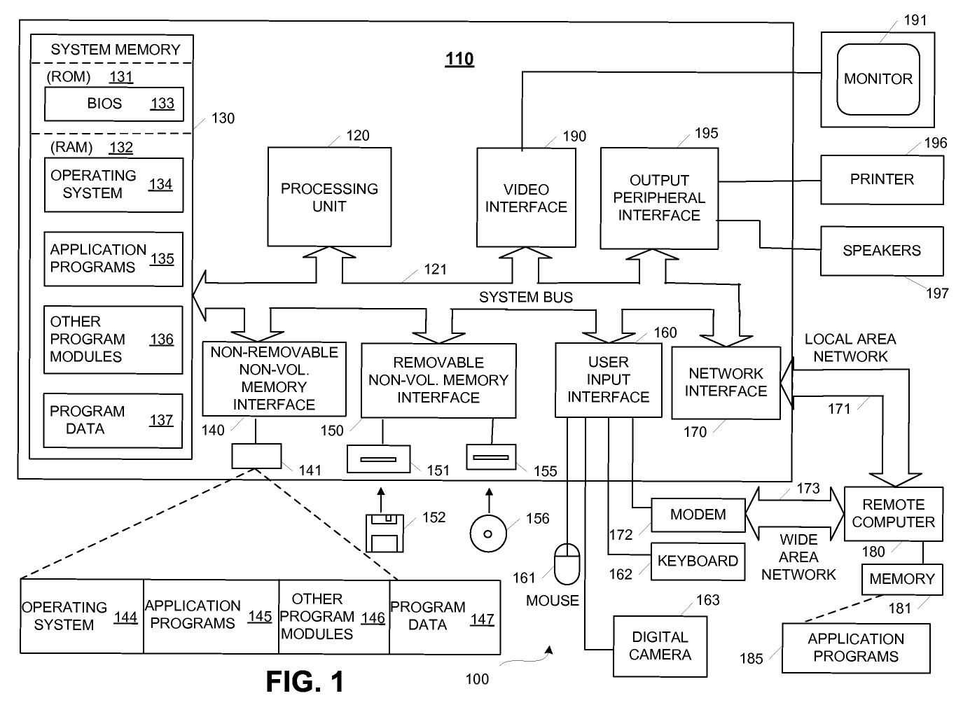

FIG. 1 illustrates an example of a suitable general purpose computing system environment 100 on which one or more illustrative aspects may be implemented. The computing system environment 100 is only one example of a suitable computing environment and is not intended to suggest any limitation as to the scope of use or functionality of features described herein. Neither should the computing environment 100 be interpreted as having any dependency or requirement relating to any one or combination of components illustrated in the exemplary operating environment 100.

Aspects are operational with numerous other general purpose or special purpose computing system environments or configurations. Examples of well known computing systems, environments, and/or configurations that may be suitable for use with aspects of the invention include, but are not limited to, personal computers; server computers; mobile phones, portable and hand-held devices such as personal digital assistants (PDAs), tablet PCs or laptop PCs; multiprocessor systems; microprocessor-based systems; set top boxes; programmable consumer electronics; network PCs; minicomputers; mainframe computers; distributed computing environments that include any of the above systems or devices; and the like.

Aspects of the invention may be described in the general context of computer-executable instructions, such as program modules, being executed by a computer. Generally, program modules include routines, programs, objects, components, data structures, etc. that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

With reference to FIG. 1, an illustrative system for implementing one or more aspects of the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Advanced Graphics Port (AGP) bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may include computer storage media and communication media. Computer storage media includes both volatile and nonvolatile and removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include electronic pen (e.g., a stylus), a microphone, joystick, game pad, satellite dish, scanner, or the like. These and other input devices are often connected to the processing unit 120 through a user input interface 160 that is coupled to the system bus 121, but may be connected by other interface and bus structures (not shown), such as a parallel port, game port or a universal serial bus (USB). A monitor 191 or other type of display device is also connected to the system bus 121 via an interface, such as a video interface 190. In addition to the monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet. For example, computer 110 may be connected to a mobile terminal (not shown) which is configured to send and receive transmissions based on the Bluetooth standard, through a specific Bluetooth module. Additionally, computer 110 may also be configured to receive, decode and process transmissions with a remote computer 180 or mobile terminal through an FM/AM radio receiver, wireless local area network (WLAN) transceiver, and/or telecommunications transceiver.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates application programs 185 as residing on memory device 181. It will be appreciated that the network connections shown are exemplary and other means of establishing a communications link between the computers may be used.

One or more aspects of the invention may be embodied in computer-executable instructions (i.e., software), such as in a notification manager software object, routine or function (collectively referred to herein as a notification manager) stored in system memory 130 or non-volatile memory 141, 152, 156 as application programs 135, 145, program modules 136, 146, and/or program data 137, 147. The software may alternatively be stored remotely, such as on remote computer 180 with application programs 185. Generally, program modules include routines, programs, objects, components, data structures, etc. that perform particular tasks or implement particular abstract data types when executed by a processor in a computer or other device. The computer executable instructions may be stored on a computer readable medium such as a hard disk 141, optical disk 156, removable storage media 152, solid state memory, RAM 132, etc. As will be appreciated by one of skill in the art, the functionality of the program modules may be combined or distributed as desired in various aspects. In addition, the functionality may be embodied in whole or in part in firmware or hardware equivalents such as integrated circuits, field programmable gate arrays (FPGA), and the like.

### Illustrative Aspects

The following aspects will refer to components compatible with Windows®-based operating systems available from the Microsoft Corporation of Redmond, Wash. It will be understood, however, that aspects of the invention will apply similarly to other operating systems including, but not limited to, Macintosh®-based operating systems available from the Apple Computer Corporation of Cupertino, Calif., and others such as Linux-based operating systems.

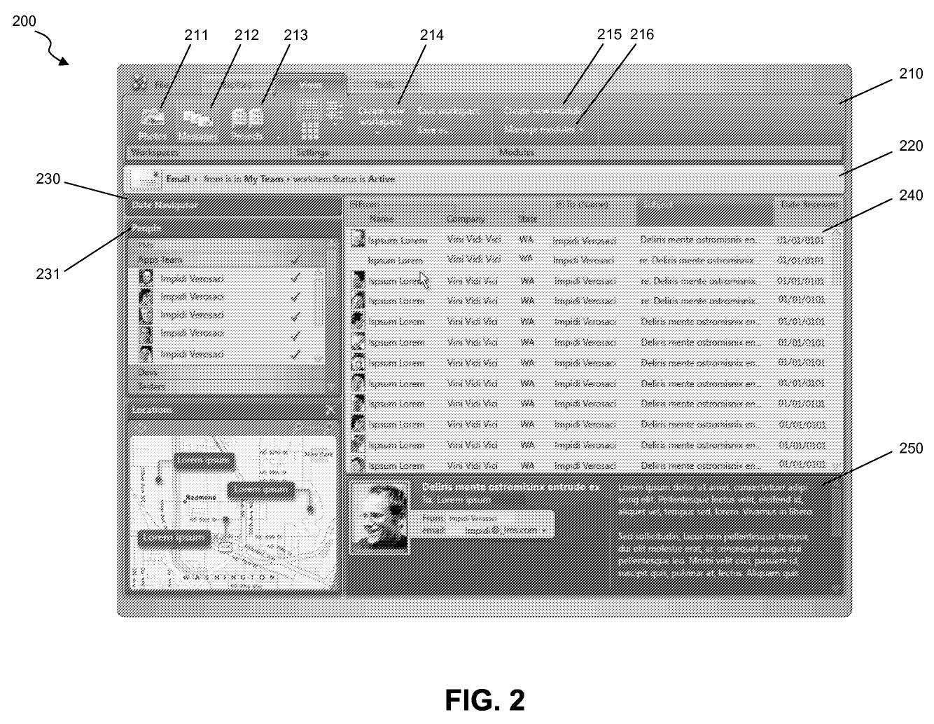

Referring to FIG. 2, an illustrative user interface screenshot is shown for creating and displaying semantic relationships between data objects on a computer system 100. As shown in FIG. 2, the user interface navigation screen 200 may be divided into multiple different regions (e.g., using browser frames, display panes, or user interface components, etc.). In this example, the navigation screen 200 includes a command selection region 210, a current location region 220, a relationship organization region 230, a collection view region 240, and a preview pane region 250.

As shown in FIG. 2, the command selection region 210 may include a customizable set of icons 211-213 corresponding to different workspaces available for loading into the collection view region 240. Workspaces typically refer to sets of related data, such as objects having the same data type or data objects compatible with a common user application. For example, the photos workspace referenced by the icon 211 may represent all of the digital still photographs stored on the computer system 100. In other implementations, workspaces may be restricted to single data types (e.g., system or application data types, or data types determined according to file extensions), so that only a single type of digital photograph (e.g., JPEG) might be displayed in the photos workspace 211. A default set of predefined system-provided workspaces may be provided in certain implementations, such as the photos, messages, and projects workspaces shown in FIG. 2. Additional common default workspaces may include: a memories workspace for photos, movies, and other multimedia content in the computer user's designated storage space; a time workspace for a user's calendar events, appointments, to-do items, and tasks; a communication workspace for a user's e-mail (e.g., organized within the workspace by folder, project, keyword, or contact); a software project bugs workspace for a user's Visual Studio Team System (VSTS) workitems (e.g., organized within the workspace by other workitems, contacts, folders, or dates), an auctions workspace for organizing a user's online auction participation (e.g., EBay auctions) and related data; an entertainment workspace for a user's music, movies, and recorded television content; a real estate workspace for data relating to user's property listings, feedback, and real-estate related communications; and an everything workspace which may include all of a user's items (e.g., organized within the workspace by folder, project, date, or contact). Additionally, workspaces may refer not only to a type of data object, but may also include an active query specifying criteria that further restrict the objects in the workspace. As described below, the active query of a workspace may be shown in the current location region 220 upon selection of the workspace. Additionally, a workspace may include associated data which describes how the objects in workspace may (or should) be viewed in the display regions of the user interface (e.g., as a list, in a grid, as points on a map, etc.). Further, the workspace may include an associated set of organization modules that will be available to the user when the workspace is selected.

Users may select a workspace icon 211-213, for example, by single-clicking with a mouse 161 or other input device, from a set of default system-provided workspaces, or may define and create their own workspaces to be added to the list of workspace icons 211-213 in the command selection region 210. A user creating her own workspace may also wish to define one or more data object types and/or other criteria such as project, date, and contact, to restrict the number of items that are displayed by the workspace. In certain implementations, a user-defined workspace may include a query created by the user. After defining a workspace/query, the user may then associate a name and icon with the new workspace to add it permanently to the list in the command selection region 210. Certain implementations may facilitate workspace creation by launching a workspace wizard, or customized workspace builder application, upon detecting that a user has selected the ‘Create new workspace’ button 214 in the command selection region 210. Additionally, functionality may be provided for users to configure existing workspaces, including both the user-created and default workspaces. For example, in certain implementations, users may right-click on an existing workspace icon 211-213 to view a list of workspace-related operations (e.g., ‘Delete Workspace’, ‘Copy Workspace’). This list may include a ‘Configure’ item that invokes the workspace wizard pre-loaded with the data for the selected workspace, allowing to user to quickly reconfigure and save changes to the updated workspaces/queries.

As an example, a user that frequently uses architectural and drafting software to create technical diagrams on his or her computer may wish to create a ‘Drafting project’ workspace containing all the drafting projects on the system. Thus, after creating this new workspace, the user would be able to view all of his or her drafting projects in a single flat list, regardless of their stored location in the file system hierarchy. As described in detail below, these default and custom workspaces may allow users to better organize their data by creating, maintaining, and viewing semantic relationships between different data objects in the workspaces.

As shown in FIG. 2, the command selection region 210 may also include a tab control, menus, and other embedded user interface controls to provide additional functionality to users interacting with the navigation screen 200. In one example, the command selection region 210 may include a tab control with the following tab items (and functions on the tab item): Home (navigate forward, navigate back, full text search, saved queries) (not shown); Explore (navigate forward, navigate back, full text search, query builder); View (individual workspaces ranked by MRU, settings, add/remove modules from the relationship organization region 230); Share (manage/create shares, configure permissions) (not shown); and Tools (extend properties, add/remove properties, initiate synchronization manager). Thus, the command selection region 210 may include additional functionality besides simply selecting a workspace to be displayed in the collection view region 240.

The current location region 220 may be used to display the active query (e.g., a currently selected workspace with an associated query), which may correspond to the set of data objects in the collection view region 240. In this example, the user has selected the messages workspace by clicking button 212 in the command selection region 210. Then, the user has further narrowed the range of messages to be displayed in the collection view region 240 by defining a query, shown in current location region 220, which states that the only messages that are to be displayed in the collection view 240 are those in which the ‘From’ property is in the ‘My team’ alias, and the ‘Workitem status’ property is ‘Active.’ As described above, queries that narrow the range of data objects shown in the collection view region 240 may be created, saved, retrieved, and executed by users using conventional query-building UI components (not shown) that may be provided in the command selection region 210.

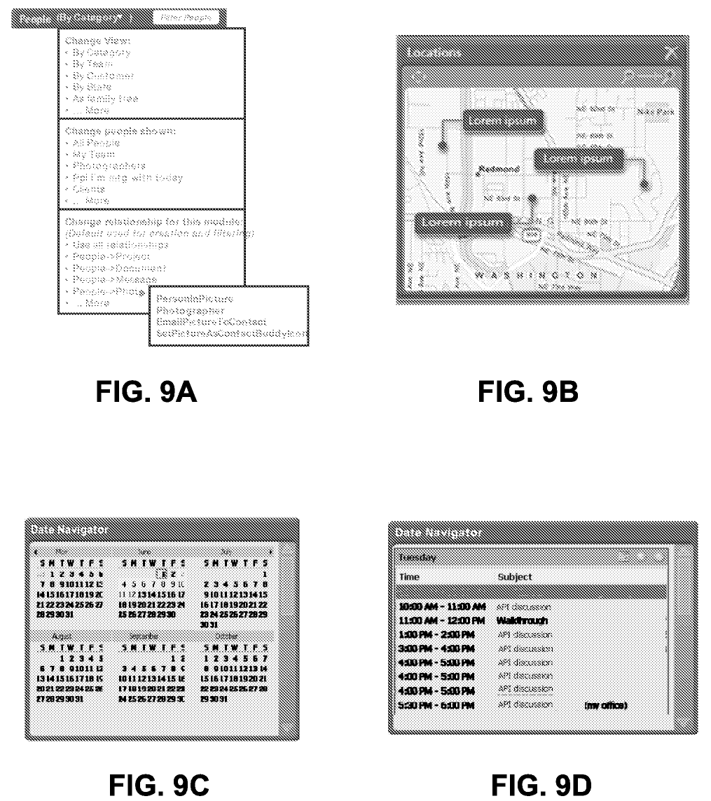

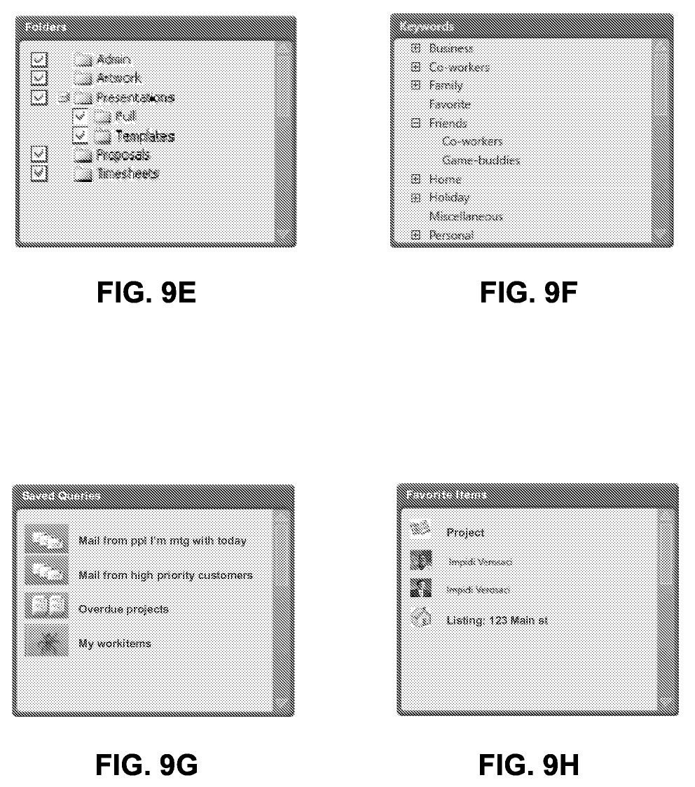

The relationship organization region 230 provides users with functionality to create and view relationships involving the data objects in the collection view region 240. Different organization modules may be plugged-in to the relationship organization region 230, to provide specific sets of data objects and/or semantic relationship types for viewing and creating relationships. For example, each workspace may include an associated set of default organization modules, so that when the workspace is selected by a user, the appropriate organization module bars (e.g., date navigator, people, locations) are automatically display in the organization region. Certain default organization modules may be pre-installed and thus are always available during interaction with the user interface, while other customized organization modules may be created and managed by users via the ‘Create new module’ and ‘Manage module’ user interface components 215 and 216. In this example, a ‘People’ organization module 231 including several distinct views corresponding to different organizational groups of people (WinFS PMs, Apps Team, Devs, Testers) has been deployed, for example, via a user selection to plug-in and initiate the module 231 in the organization region 230. As described in detail below, users may interact with the data objects in the organization modules to define semantic relationships between those objects and the items in the collection view region 240. Additionally, while this example shows a simple ‘People’ module 231, many different types of organization modules, including different data object types and different display characteristics, may be used in the organization region 230. Several other examples of organization modules are described below in reference to FIGS. 9A-9H.

The collection view region 240 may contain references to the data objects returned by the most recent workspace and query selections, which are also shown in the current location region 220. The collection view region 240 in this example is displayed as a grid including a set of sortable properties arranged in columns. In certain embodiments, the collection view 240 may be customized by the user to add/remove and sort the objects using the properties from the view 240. In this example, each data object from the messages workspace that meets the criteria of the current query should be displayed as a row in the collection view region 240. The Sender Name, Company, State, Recipient Name, Subject, and Date Received properties are displayed for each item as columns in the collection view 240.

The preview pane region 250 may display addition details for an item that has been selected from the collection view region 240. In this example, the top message in the collection view has been selected, causing additional information about this message (e.g., the senders e-mail address, and the first several lines of the message body) are shown in the preview pane region 250. Using commonly known techniques, the information shown in the preview pane region 250 may be user-customizable and may also be configured to depend on the data object type of the selected item. For example, if a digital music file were selected from a listing of media files in the collection view region 240, then the preview pane region 250 might contain the song length, artist, and album name properties, and other information that would likely be inapplicable to other data object types. As another example, if a data object corresponding to a person were selected from a list of people in the collection view region 240, the preview pane region 250 may include the selected individual's contact information, and their company/organizational information. Additionally, in certain implementations, the preview pane region 250 may be configured to display data objects selected from the relationship organization region 230, rather than just from the collection view region 240.

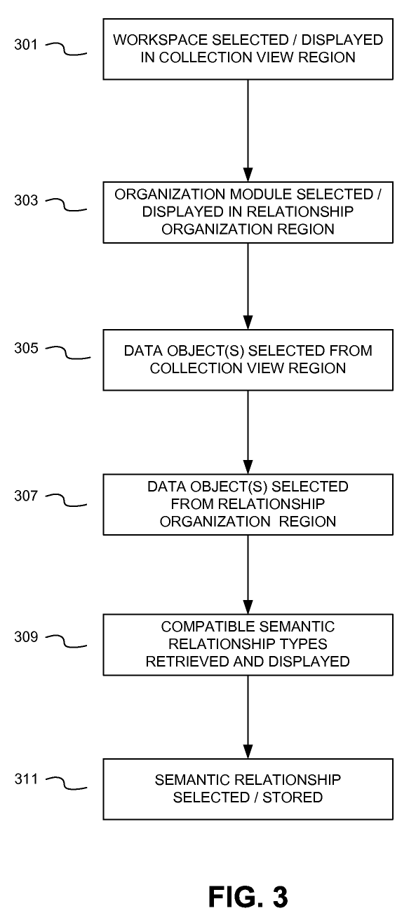

Referring to FIG. 3, a flow diagram is shown illustrating a technique for creating semantic relationships between items shown in the collection view region 240 and the relationship organization region 230. A semantic relationship refers to an association between two or more different data objects on the computer system 100 that includes some additional meaningful information about the relationship, rather than simply identifying the associated objects. As noted above, data objects of certain types may be related to one another in a variety of different logical ways. For example, it may be possible to relate a person to photograph in multiple different ways. To illustrate, a semantic relationship indicating “Person A is in Photograph X,” clearly has a different meaning than a semantic relationship indicating “Person A is the photographer of Photograph X,” even though syntactically both relationships may define the same association (i.e., a connection between Person A and Photograph X). Thus, different semantic relationships may be defined depending on the data object types of the information that is to be related.

Further, the different meanings of the semantic relationship types may correspond to different properties and rules stored on the system, which may be used to control the behavior of the user experience in creating and maintaining relationships. Using the above example, the ‘photographer’ semantic relationship between person objects and photograph objects might be restricted to one-to-many relationships, indicating that each person might take multiple photographs but each photograph has only one photographer. In contrast, the ‘people in picture’ semantic relationship may allow many-to-many relationships, indicating that more than one person (as well as other data object types) may be captured in a single photograph.

In step 301, the user selects a workspace for displaying items in the collection view region 240. As mentioned above, a user-selected workspace may correspond to a type of data object stored on the computer system 100, and may be further narrowed by a user-created query specifying a range or criteria for the data objects of the selected type that should be displayed in the collection view 240. In this example shown in FIG. 2, the user has selected the ‘Messages’ workspace, and further narrowed that workspace with a query indicating that only e-mail messages from members of the ‘My Team’ alias and that have a ‘Workitem Status’ property of ‘Active’ should be displayed in the collection view region 240.

In step 303, the user selects an organization module to be deployed in the relationship organization region 230. As mentioned above, the ‘People’ organization module 231 shown in FIG. 2 corresponds to a list of people that has been divided into company organizational groups for greater usability. Of course, steps 301 and 303 need not require a new user selection, as automatic defaults for workspaces, queries, and organization modules may be pre-defined or user-defined, and stored on the computer system 100 to automatically fill their respective display regions 230 and 240 when the user accesses the navigation screen 200.

In step 305, the user may select one or more data objects from the collection view region 240, for example, by mouse-clicking on a data object in the collection view region 240 (or by using shift-clicking/control-clicking for select multiple objects at once). In step 307, the user may similarly select one or more items from the organization module 231 displayed in the organization region 230.

In step 309, after one or more objects have been selected from both the collection view region 240 and the organization region 230, the computer system 100 may retrieve and display the different possible types of semantic relationships associated with the selected data object types. As an example, if only two data objects have been selected, a person (Tom) and a project proposal document stored on the computer (Proposal1), then the different semantic relationship types may correspond to several different ways in which the two objects might be related (e.g., ‘Tom is the sponsor of Proposal1’, ‘Tom is in process of reviewing Proposal1’, ‘Tom has approved Proposal1’, ‘Tom objects to Proposal1’, etc.) Of course, the different semantic relationship types may depend on the data object types, the installed software applications, and the user functionality supported by the computer system 100. Thus, a different set of semantic relationship types may exist for different combinations of data object types. Additionally, a different set of semantic relationship types may exist for the same combination of data object types operating on different computer systems 100.

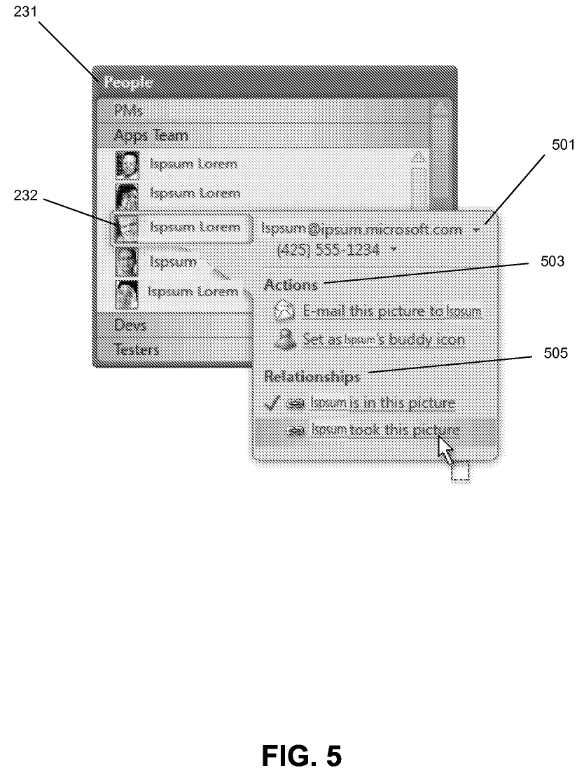

In this example, step 309 may also involve displaying the set of possible semantic relationship types to the user (e.g., via the navigation screen user interface 200). A screenshot illustrating one possible technique for displaying semantic relationship types is shown in FIG. 5. As shown in FIG. 5, the user has selected (e.g., by clicking, double-clicking, or right-clicking) a specific person 232 in the ‘People’ organization module 231, while one or more pictures have been selected in a collection view (not shown). In another example, the user may drag-and-drop the person 232 from the organization module 231 onto a picture in the collection view, or vice versa. In response to the person selection, a pop-up window 501 is initiated and displayed on the user interface, containing contact information for the person 232, along with a set of semantic relationship types that are compatible with person data objects and picture data objects. In this example, the set of semantic relationship types includes both a list of actions 503 that may be taken relating to the selected picture(s) and the user 232, as well as a set of persistent semantic relationships 505 that can be created for between the selected picture(s) and the user 232.

Referring again to FIG. 3, in step 311, the semantic relationships selected by the user (e.g., from the semantic relationship list 505) are stored on the memory of the computer system 100. In certain embodiments, a user selection of an action from the actions list 503 might not be stored in memory or persisted in any way. That is, the chosen action (e.g., e-mailing the picture to the selected person 232, setting the picture as an Instant Messaging buddy icon for the selected person 232) may initiate a software response from an application on the computer (e.g., opening the default e-mail editor and creating a new e-mail message with the selected person 232 in the address line), but unlike the relationships list 505, the selection of an action might not be saved for future retrieval. In other embodiments, both user-selected actions and relationships may be stored in memory, for example, to allow users to later review both the relationships and the different actions that have previously been initiated with respect to different data objects.

As shown in FIG. 5, after a relationship is selected from the relationship list 505, an indication of that selection (e.g., a check mark or highlighting of the list item) denotes that the relationship has been created and stored on the system. Thus, when this user or another user invokes the pop-up window 501 or a similar view, the user may immediately be informed of which semantic relationships exist between the two items, and may then use the same view to remove or change these relationships.

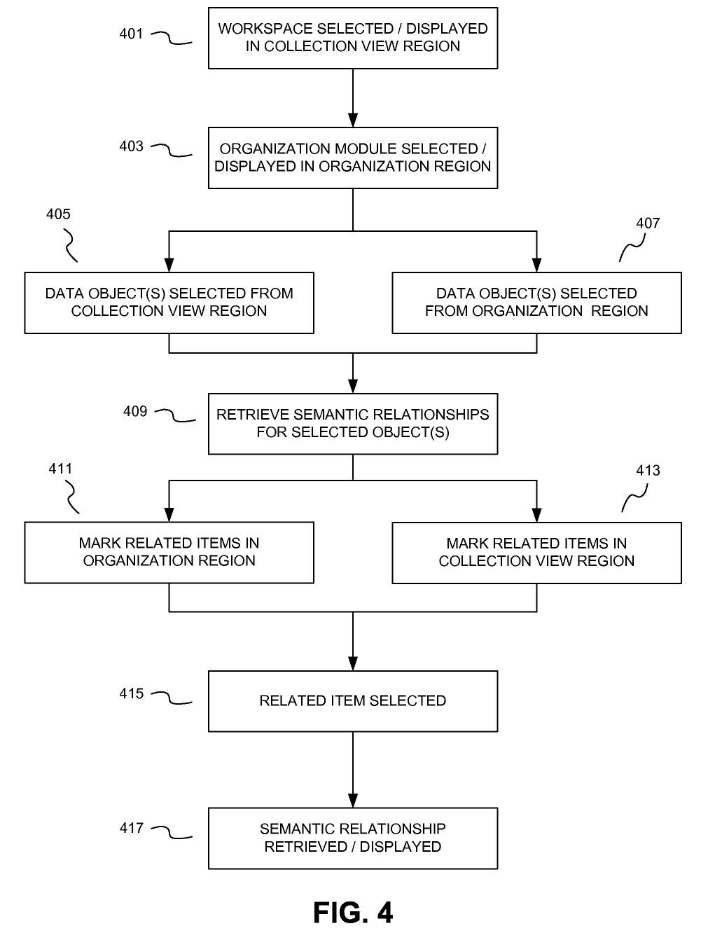

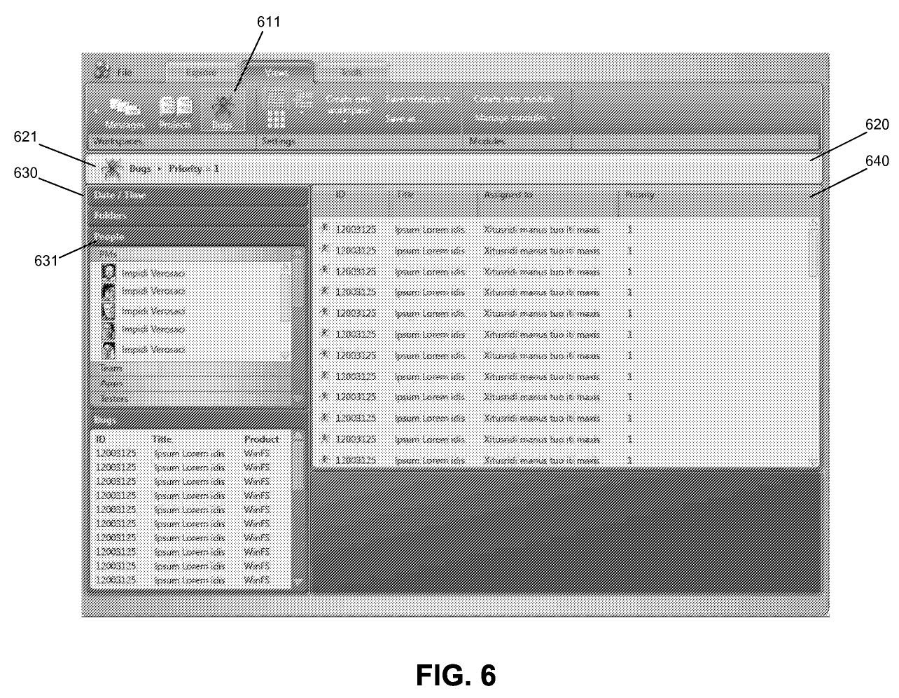

FIG. 4, a flow diagram illustrating additional techniques for retrieving and displaying semantic relationships, will now be described with reference to the navigation screen computer user interface shown in FIG. 6. In step 401, as previously described, a user may select a workspace and/or query which may automatically display a set of data objects in a display pane (e.g., collection view region 640) of the user interface. Also as similarly described above, in step 403, the user may select an organization module which may automatically display a different set of objects in a different display pane (e.g., relationship organization region 630) of the user interface.

Thus, after steps 401 and 403 are completed, the user has selected a workspace and query, shown respectively by the selection of the ‘Bugs’ workspace icon 611 and the query 621 displayed in the current location region 620. Accordingly, the collection view region 640 has been populated with a corresponding set of data objects (i.e., bugs with a ‘Priority’ property value equal to ‘1’ in this example). The user has also selected a ‘People’ organization module 631 to be displayed in the relationship organization region 630 of the user interface. As shown in FIG. 6, the people module 631 may be just one of several modules which are available and displayed concurrently in the organization region 630.

Then, either in step 405 or step 407, a user-selection of a data object is detected. This selection may correspond to either an object in the collection view region 640 (in step 405) or an object in the organization region 630 (in step 407). Upon selection of a data object, a query may be executed in step 409 to retrieve an existing set of semantic relationships involving the selected data object. For example, in FIG. 6, if a single bug object is selected from the collection view region 640, step 409 may invoke a query for all people in the ‘People’ organization module 631 that have an existing semantic relationship to the selected bug (e.g., a person in organization module 631 who opened the bug, resolved the bug, or has approved of a bug fix within a certain development milestone, etc.). Alternatively, in this example, if a person is selected from the organization module 631 in the organization region 630, then step 409 may invoke a query for all bugs in the collection view region 640 that have an existing semantic relationship to the selected person.

In steps 411 and 413, the user interface is updated to mark the related data objects retrieved in step 409, based on the stored semantic relationships of the selected item. In this example, if a bug was selected from collection view region 640 in step 405, then the retrieved set of related people would be identified (in step 411) in the organization region 630. Similarly, if a person was selected from the organization region 630 in step 407, then the retrieved set of related bugs would be identified (in step 413) in the collection view region 640. Identifying related data objects may include commonly known user interface techniques, such as highlighting the user-selected data object while displaying check marks next to each of the related data objects in the other display pane(s). Steps 411 and 413 may also involve filtering the data objects in the display panes of the user interface, for example, by removing all of the data objects in any of the other display panes that do have an existing semantic relationship with the selected object. Thus, for example, the selection of a person from the organization region 630 in step 407 may invoke a filtering function against the collection view region 640, removing from the collection view region 640 any bug that is not related by a stored semantic relationship to the selected user.

In certain situations, a user might simply be interested in knowing which data objects are related to certain other data objects, and might not ever need the exact semantic description of the relationship between the objects. Thus, such a user might not need to progress beyond step 411 or 413 in the diagram of FIG. 4. However, when a user may wish to view or update the semantic relationships between the data object selected in step 405-407 and the related data objects retrieved in step 409, certain aspects of the present invention permit a user to do so by selecting a marked related data object in step 415. That is, if a user wants to view the specific type/description of an object's semantic relationships, rather than just seeing which objects are affected by one or more semantic relationships, the user may view this additional information by selecting a marked object in step 415. As an example, if a bug had been selected in the collection view region 640, and in response to that selection several people were marked with a check mark in the organization region 630, a user may then be able to selected one of the marked people (e.g., by clicking, right-clicking, dragging-and-dropping, etc.), to view the details and descriptions of the specific semantic relationships between the two objects. Thus, in step 417, if the relationship descriptions have not already been retrieved from the memory of the computer system 100, they are retrieved, for example, by executing a query that returns the text description of each identified semantic relationship between the two objects. Finally, the retrieved descriptions of the semantic relationships and other detailed information for the relationship may be displayed on the user interface, allowing the user to view, modify, or remove any of the existing relationships. Additionally, in step 417, the other types of semantic relationships possible for these two objects might also be retrieved, as described above with reference to FIGS. 3 and 5, so that users may conveniently add new relationships between the data objects from this point in the user interface.

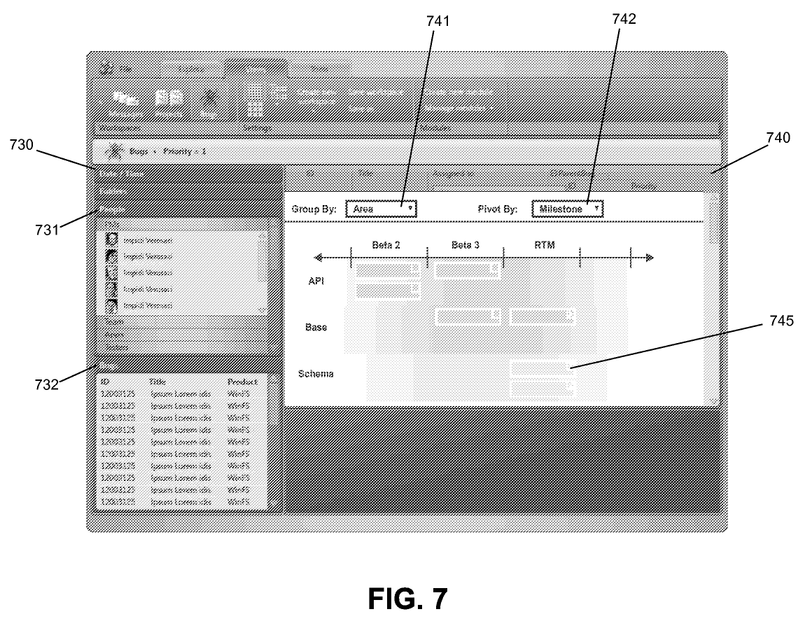

Additional aspects of the user experience will now be described with reference to the user interface screen shots in FIGS. 7-9H. FIG. 7 shows a user interface navigation screen in a similar state to the one described above in FIG. 6. However, the collection view region 740 is not displayed as a grid or table as shown in FIG. 6, but rather is displayed in a graph pivoted by the bug milestone, in which the bugs in each milestone are further grouped by area. The graphical collection view region 740 in this example also supports user customization through use of the group-by component 741 and pivot-by component 742, allowing users to sort and display the bugs in the collection view region 740 graphically in a variety of different configurations. Graphical (i.e., non-grid) displays for data objects may also be used for organization modules in the relationship organization region 730.

As shown by the collection view region 740 of FIG. 7, some graphical data object displays might not support individual representation of data objects on the user interface navigation screen. Thus, when users wish to create or retrieve semantic relationships for such objects, they may typically select an entire block of data objects, rather than a single object as was described in FIG. 6. For example, in certain implementations, a user may click on the displayed bug group 745 (i.e., corresponding to all bugs in which the ‘Priority’ property equals ‘1,’ the ‘Area’ property equals ‘Schema’, and the ‘Milestone’ property equals ‘RTM’), in order to create or retrieve semantic relationships with any of the bugs in the group 745, effectively providing convenient multi-select functionality. Thus, to illustrate, a user might select the group 745, followed by a person in the organization module 731, to create the same semantic relationship between the selected person and each of the bugs in the group 745.

An additional feature related to the graphical data object display of FIG. 7, relates to the previously described filtering functionality while viewing semantic relationships. In FIG. 7, before selecting any bugs or groups of bugs from the collection view region 740, the user might select a person from the organization module 731, thereby triggering a filtering of the collection view region 740. In this example, each bug in the collection view region 740 not related to the selected person might be filtered out of the collection view region 740, thus reducing the size of many of the bug groups shown in the collection view region 740.

Additionally, FIG. 7 concurrently shows a second organization module 732 in the organization region 730, displaying a grid listing relevant details of individual bugs. Thus, in another example, a user might select one or more of the individual bugs in the organization module 732, which may also trigger a filtering on the collection view region 740, once again reducing the size of many of the bug groups shown in the collection view display pane by removing the references to all bugs other than those with semantic relationships to the selected bugs. As this example illustrates, it is possible using certain embodiments to create and maintain semantic relationships between different data objects of the same type.

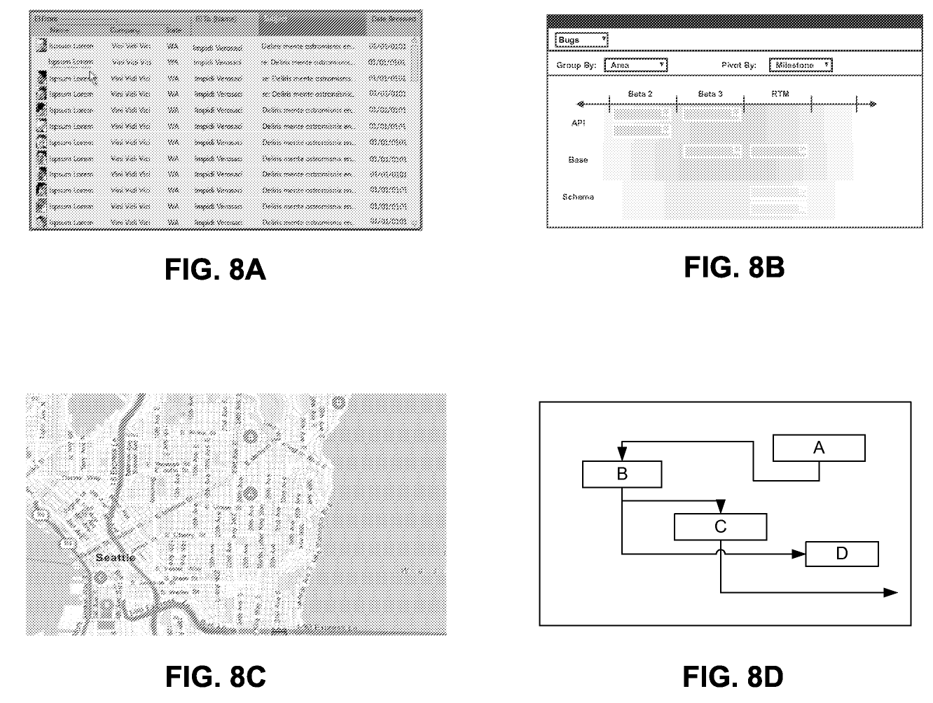

FIGS. 8A-8D show user interface components which illustrate additional possible variations for displaying data objects in a collection view. The collection views shown in FIG. 8A (grid view) and FIG. 8B (pivot view) have been described respectively above in FIGS. 6 and 7. FIG. 8C is a collection view displayed as a set of data objects on a background map. The map view of FIG. 8C may be used to create and maintain semantic relationships between data objects representing geographically separated items. FIG. 8D is collection view rendered as a chart, showing data objects as different components in a system or flow diagram. Of course, FIGS. 8A-8D merely show a few illustrative variations for displaying collection views of data objects in a user interface. Many other collection views may be provided, along with additional functionality allowing users and third-party developers to create different collection views capable of execution with the user interfaces described in these examples and in accordance with one or more aspects of the present invention.

FIGS. 9A-9H show user interface components which illustrate additional possible menu options and/or organization modules that may be used for creating and maintaining semantic relationships among the data objects. FIG. 9A illustrates a possible menu option which may be available on a variation of the ‘People’ organization module described above with reference to FIGS. 6 and 7. The menu option shown in FIG. 9A may be interactive, allowing users to change the view, add or remove people or groups of people, and to define the types of semantic relationship that may be created using the module. Additional functionality supported by this menu option may also allow users to determine how the organization module is viewed within its display pane (e.g., relationship organization region 730). For example, the module associated with the menu option in FIG. 9A may implement functions to allow dragging, minimizing, and resizing so that this module may be displayed concurrently with other organization modules in the same organization region 730. Of course, additional menu options may be implemented to provide similar functionality for other types of organization modules (e.g., dates, locations, folders, etc.).

FIG. 9B shows a location module, similar to the map view shown in FIG. 8C, representing data objects by geographic locations on a background map. FIGS. 9C and 9D show date/event navigators which have been implemented into organization modules. In certain embodiments, an organization module such as the date navigator shown in FIG. 9C need not display actual data objects, but may instead simply show ranges of property values (e.g., dates), which may be used to maintain property values for the data objects in the collection view, using similar techniques to those described above for creating and maintaining semantic relationships. In contrast, in FIG. 9D, the items contained in the date navigator module shown may in fact correspond to actual data objects (e.g., tasks, appointments, etc.) stored on the computer system 100. Thus, the organization module of FIG. 9D could be used to create and maintain semantic relationships for these items, as well as to manipulate the related property values of the data objects from the other views in the user interface.

FIG. 9E shows an organization module implemented as a hierarchical folder view, and FIG. 9F shows a similar organization module implemented as a keyword hierarchy. The organization module in FIG. 9G contains a list of user-created or system-created queries saved on the computer, each of which defines a workspace and criteria for displaying a set of data objects in a collection view of the user interface. FIG. 9H shows an organization module implemented as a list of user-defined favorite items. In this example, each of the items in the list represents a different data object stored on the computer system 10;, however, unlike lists in many previous examples, the list of FIG. 9H includes data objects of different types. Thus, when using the organization module of FIG. 9H to create and maintain semantic relationships, different relationship types may apply to the different items in the module.

While illustrative systems and methods as described herein embodying various aspects of the present invention are shown, it will be understood by those skilled in the art, that the invention is not so limited. Modifications may be made by those skilled in the art, particularly in light of the foregoing teachings. It will also be appreciated and understood that modifications may be made without departing from the true spirit and scope of the present invention. The description is thus to be regarded as illustrative instead of restrictive on the present invention.

What is claimed is:

1. A method for maintaining relationships between objects on a computer system, comprising:
displaying references corresponding to a first set of data objects in a first display pane in a computer user interface;
displaying references corresponding to a second set of data objects in a second display pane in the computer user interface;
receiving a first user selection input corresponding to a first data object having a first data object type in the first set of data objects;
receiving a second user selection input corresponding to a second data object having a second data object type in the second set of data objects;
determining one or more semantic relationship types based on the first data object type and the second data object type; and
displaying the one or more semantic relationship types in a third display pane via the computer user interface.

2. The method of claim 1, further comprising:
receiving a third user selection input corresponding to one of the one or more semantic relationship types displayed; and
responsive to the third user selection input, storing in the computer system a semantic relationship corresponding to the first data object, the second data object, and the third user selection input.

3. The method of claim 1, wherein each data object of the first set of data objects has the same data object type.

4. The method of claim 1, wherein the first user selection input corresponds to a plurality of data objects having the first data object type.

5. The method of claim 1, wherein the one or more semantic relationship types includes an action to be taken on the first data object.

6. The method of claim 1, wherein the one or more semantic relationship types includes a description of an association between the first data object and the second data object.

7. The method of claim 1, wherein receiving the first user selection input and the second user selection input includes detecting a drag-and-drop operation from the second display pane to the first display pane.

8. A computing device comprising:
a processor controlling at least some operations of the computing device;
a memory storing computer executable instructions that, when executed by the processor, cause the computing device to perform a method for retrieving relationships between objects on the computing device, the method comprising:
displaying references corresponding to a first set of data objects in a first display pane in a user interface on the computing device;
displaying references corresponding to a second set of data objects in a second display pane in the user interface on the computing device;
receiving a first user selection input corresponding to a first data object in the first set of data objects;
retrieving from the memory one or more semantic relationships associated with the first data object; and
updating the user interface based on the one or more retrieved semantic relationships.

9. The computing device of claim 8, wherein updating the user interface includes displaying a pop-up user interface component listing the one or more retrieved semantic relationships.

10. The computing device of claim 8, wherein updating the user interface includes:
based on the one or more retrieved semantic relationships, identifying a subset of objects in the second set of data objects that are not associated with the first data object; and
removing the references corresponding to the identified subset of objects from the second display pane.

11. The computing device of claim 8, wherein updating the user interface includes:
based on the one or more retrieved semantic relationships, identifying a subset of objects in the second set of data objects that are associated with the first data object; and
marking the identified subset of objects in the second display pane.

12. The computing device of claim 8, wherein the one or more retrieved semantic relationships includes a relationship between the first data object and one of the second set of data objects.

13. The computing device of claim 8, wherein the one or more retrieved semantic relationships includes a relationship between the first data object and two or more of the second set of data objects.

14. The computing device of claim 8, wherein the one or more retrieved semantic relationships includes a relationship between two different data objects in the first set of data objects.

15. One or more computer readable media storing computer-executable instructions which, when executed on a computer system, perform a method comprising:
displaying references corresponding to a first set of data objects in a first display pane in a computer user interface;
displaying references corresponding to a second set of data objects in a second display pane in the computer user interface;
receiving a first user selection input corresponding to a first data object having a first data object type in the first set of data objects;
receiving a second user selection input corresponding to a second data object having a second data object type in the second set of data objects;
determining one or more semantic relationship types based on the first data object type and the second data object type; and
displaying the one or more semantic relationship types in a third display pane via the computer user interface.

16. The computer readable media of claim 15, wherein the method further comprises:
receiving a third user selection input corresponding to one of the one or more semantic relationship types displayed; and
responsive to the third user selection input, storing in the computer system a semantic relationship corresponding to the first data object, the second data object, and the third user selection input.

17. The computer readable media of claim 15, wherein the first set of data objects includes at least two different data objects having different data object types.

18. The computer readable media of claim 15, wherein the one or more semantic relationship types includes an action to be taken on the first data object.

19. The computer readable media of claim 15, wherein the one or more semantic relationship types includes a description of an association between the first data object and the second data object.

20. The computer readable media of claim 15, wherein receiving the first user selection input and the second user selection input includes detecting a drag-and-drop operation from the second display pane to the first display pane.
